(19) United States
(12) Patent Application Publication
(10) Pub. No.: US 2007/0006527 A1
(43) Pub. Date: Jan. 11, 2007

(54) FLOWERPOT FOR GROWING FLOWER

(76) Inventor: Chen-Che Chen, Chi Kou Hsiang (TW)

Correspondence Address: NIKOLAI & MERSEREAU, P.A., 900 SECOND AVENUE SOUTH, SUITE 820, MINNEAPOLIS, MN, 55402, US

(21) Appl. No.: 11/160,784

(22) Filed: Jul. 8, 2005

(51) Int. Cl. A01G 31/00

(52) U.S. Cl. 47/61

(57) ABSTRACT

A flowerpot comprises a first container containing an expanding member placed and a second container. The second container contains a fertilizing member and a seed buried in the fertilizing member. In use, pour water into the first container will cause the expanding member to expand by absorbing water for gradually raising the second container, and will cause water to enter the fertilizing member in the second container such that the seed is adapted to grow and extend out of the second container by exploding same.

### BACKGROUND OF THE INVENTION

1. Field of Invention

The present invention relates to flowerpots and more particularly to a flowerpot for growing flower and for viewing the process of the growth of the seed.

2. Related Art

A conventional pot 1 for growing flower is shown in FIGS. 1 and 2. In FIG. 1, the pot 1 comprises a transparent cylinder 111 having a blinded bottom, a cover 12 put on an open top of the cylinder 11, a hollow container 13 provided in the cylinder 11, a plurality of expanders 14 and vermiculites 15 filled in the container 13, and a seed 16 buried in the expanders 14 and vermiculites 15. The container 13 further has a bottom opening 131.

In FIG. 2, when water is poured into the container 13 after removing the cover 12, it will enter into the container 13 from the opening 131. Then, the expanders 14 will expand by absorbing the water and explode the container 13. The seed 16 then grows out of the container 13. Finally, the seed 16 grows out of the cylinder 111 by absorbing nutrition of water and vermiculites 15.

Though a user can view the explosion of the container 13 and the growth of the seed through the transparent cylinder 11 at the first irrigation, the prior art suffered from some disadvantages. For example, the container 13 is fixedly in the cylinder 11. Thus, no dynamic growth of the seed 16 is possible. Hence, a person owned the pot 1 may be not interested in it anymore after a short period time of use. Thus, the need for improvement still exists.

### SUMMARY OF THE INVENTION

It is therefore an object of the present invention to provide a flowerpot comprising a first container including a first space, an expanding member placed on the bottom of the first container, a second container including a second space and a bottom opening, a fertilizing member provided in the second space, and a seed buried in the fertilizing member. The second container is provided in the first space and on the expanding member. Pour water into the first space of the first container will cause the expanding member to expand by absorbing water for gradually raising the second container, and will cause water to enter the second space of the second container through the opening for fertilizing the seed such that the seed is adapted to grow and extend out of the second container by exploding same.

The above and other objects, features and advantages of the present invention will become apparent from the following detailed description taken with the accompanying drawings.

### BRIEF DESCRIPTION OF THE DRAWINGS

FIG. 1 is a sectional view of a conventional pot for growing flowers where the seed has not grown;

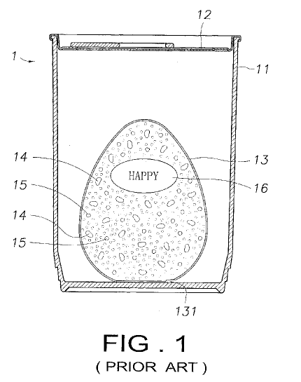

FIG. 2 is a view similar to FIG. 1, where the seed has grown out of the pot;

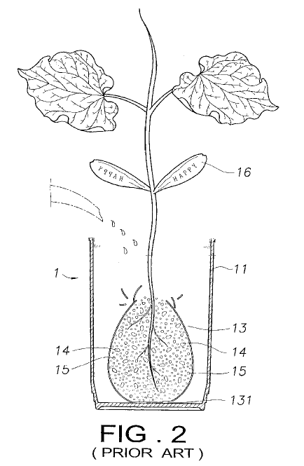

FIG. 3 is an exploded view of a first preferred embodiment of a pot for growing flower according to the invention;

FIG. 4 is a perspective view of the assembled pot shown in FIG. 3;

FIG. 5 is a view similar to FIG. 4, where the seed has grown out of the pot; and

FIG. 6 is a side view in part section of a second preferred embodiment of a pot for growing flower according to the invention.

### DETAILED DESCRIPTION OF THE INVENTION

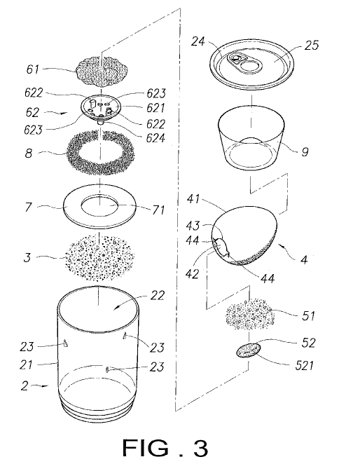

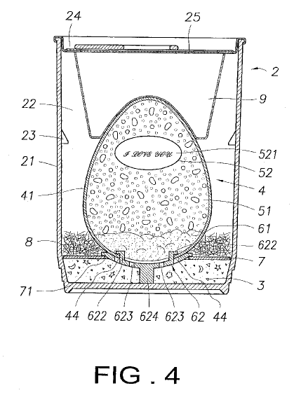

Referring to FIGS. 3 and 4, a pot for growing flower in accordance with a first preferred embodiment of the invention comprises a first container 2, an expanding member 3, a second container 4, a fertilizing member 51, a seed 52, a blocking member 61, a circular seat 62, a ring 4 and at least one decorative member 8.

The first container 2 has an open top and comprises a cylindrical wall 21 made of transparent material, a first space 22 defined by the wall 21, a plurality of limiting members 23 on the inside of the wall 21, an annular stop member 24 provided on the top of the wall 21, and an openable cover 25. The limiting members 23 can be at least one projection or an annular flange formed on an inner surface of the wall 21. The stop member 24 can also be a peripheral rim of the cover 25 adapted to cover on the top of the wall 21. The first container 2 may be a pop-top can or a container with a separate cover. The first container 2 may be shaped of rectangular or cylinder. Also, the first container 2 may be formed of plastic material, wood, metal or the like.

The expanding member 3 is placed on the bottom of the first space 22. The expanding member 3 is a well-known element which will expand after absorbing water.

The second container 4 is provided in the first space 22 and above the expanding member 3. The second container 4 comprises a shell 41, a second space 42 defined by the shell 41, an opening 43 on the shell 41, and two recesses 44 at both sides of the opening 43. A maximum diameter of the shell 41 is bigger than an inner diameter of the stop member 24. Thus, the second container 4 is prevented from leaving the first container 2. In this embodiment, the second container 4 is egg-shaped. It may also have a shape other than egg in another embodiment.

The fertilizing member 51 is provided in the second space 42 comprised of a plurality of vermiculites having similar constituent components as long-acting slow-release fertilizer or the like.

The seed 52 is buried in the fertilizing member 51. A string of words or patterns 521 may be formed on the surface of the seed 52 by laser.

The blocking member 61 is formed of an absorbent material and is stuffed into the opening 43. As such, water can enter the second space 42 through the opening 43 and both the fertilizing member 51 and the seed 52 are prevented from leaving the second space 42 through the opening 43. In the embodiment, the blocking member 61 is cotton. It may also be of other materials in another embodiment.

The circular seat 62 comprises a concave surface 621 facing the opening 43 of the second container 4, the surface 621 being conformed to the opening 43, two opposite hooks 622 on the surface 621 respectively inserted through the recesses 44, a plurality of holes 623 extend through the surface 621 for permitting water to flow therethrough, and a peg 624 on the underside of the surface 621. In assembly, rotate the seat 62 relative to the second container 4 to fasten the seat 62 at the bottom of the second container 4.

The ring 7 is placed on the expanding member 3 and comprises a central opening 71 with the second container 4 seated thereon.

The ring-shaped decorative member 8 is placed in the first space 22 and around a lower portion of the second container 4. The decorative member 8 may comprised of a plurality of paper shreds with star-shaped patterns or the like to increase visual attractiveness.

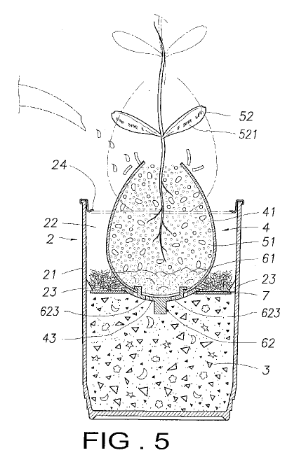

Referring to FIG. 5, in use, removing the cover 25 and pour water into the space 22 of the first container 2. The expanding member 3 will expand by absorbing water. Hence, components disposed above the expanding member 3 rise gradually (i.e., the second container 4 rises). Such rising will be stopped when the ring 7 reaches the limiting members 23. At the same time, water will enter the second space 42 through the holes 623 of the seat 62, the blocking member 61 and the opening 43. Next, both the seed 52 and the fertilizing member 51 grow to explode the shell 41 by absorbing water. Finally, the seed 52 grows and extends out of the second container 4 by absorbing nutrition from the water and fertilizing member 51.

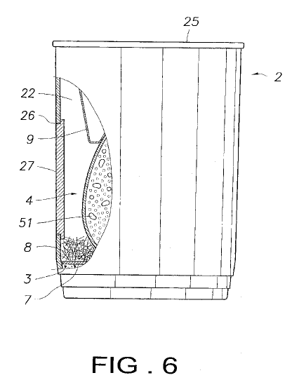

Referring to FIG. 6, a pot for growing flowers in accordance with a further preferred embodiment of the invention is shown. The characteristics of the second preferred embodiment are detailed below. The first container 2 is formed of opaque material. A window 26 is formed on a circumferential surface of the first container 2. The window 26 is sealed by a piece of transparent plate 27. As such, a user may view the process of growth of the seed through the transparent plate 27.

It is noted that in an embodiment other than above, the cover 25, the peg 624, or the decorative member 8 can be eliminated. Also, the element for stopping the rising of the second container 4 can be just selected from the limiting members 23, the stop member 24 or a combination thereof. Further, one or two of the blocking member 61, the seat 62, and the ring 7 can be eliminated. Furthermore, expander can be also added in the fertilizing member 51 for facilitating the seed 52 to grow and extend out of the second container 4. Furthermore, a positioning member 9 may be provided between the cover 25 and the second container 4 for positioning components within the first container 2 before removing the cover.

As described above, when a user irrigating, the second container 4 will rise and crack and then the plant with a string of words or patterns 521 grows and exposes. The Pandora boxlike pot according to the invention can bring a lot of magic to a person who likes to grow flowers.

While the invention herein disclosed has been described by means of specific embodiments, numerous modifications and variations could be made thereto by those skilled in the art without departing from the scope and spirit of the invention set forth in the claims.

What is claimed is:

1. A flowerpot comprising:
a first container including a first space;
an expanding member placed on the bottom of the first container;
a second container provided in the first space and on the expanding member, the second container including a second space and a bottom opening;
a fertilizing member provided in the second space; and
a seed buried in the fertilizing member;
whereby pouring water into the first space of the first container will cause the expanding member to expand by absorbing water for gradually rising the second container, and will cause water to enter the second space of the second container through the opening for fertilizing the seed such that the seed is adapted to grow and extend out of the second container by exploding same.

2. The flowerpot of claim 1, wherein the first container further comprises a wall to define the first space and a plurality of limiting members formed on its inner such that the raising of the second container will be stopped by the limiting members.

3. The flowerpot of claim 1, wherein the first container further comprises a stop member on the top to prevent the second container leaving the first container.

4. The flowerpot of claim 1, wherein the first container is a pop-top can having a cylindrical wall with a top opening and an openable lid covered on the top opening.

5. The flowerpot of claim 1, wherein the first container is transparent.

6. The flowerpot of claim 1, wherein the first container is opaque and comprises a window formed on its peripheral surface sealed by a transparent plate.

7. The flowerpot of claim 1, further comprising a blocking member stuffed into the opening of the second container to permit water enter the second space and prevent the fertilizing member and the seed from leaving the second space through the opening.

8. The flowerpot of claim 1, further comprising a seat for securing to the second container having at least one hole for water flow.

9. The flowerpot of claim 1, wherein the second container further comprises at least one recess at the side of the opening, the seat further comprises a concave surface for closing the opening and at least one hook corresponding to and inserted through the recess, whereby rotating the seat relative to the second container to fasten the seat at the bottom of the second container.

10. The flowerpot of claim 1, further comprising a ring placed on the expanding member having a central opening with the second container seated thereon.
